(19) United States
(12) Patent Application Publication
(10) Pub. No.: US 2009/0205043 A1
(43) Pub. Date: Aug. 13, 2009

(54) INFORMATION PROCESSING SYSTEM, INFORMATION PROCESSING METHOD, AND COMPUTER READABLE MEDIUM

(75) Inventor: Masaki ABE, Kawasaki-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/257,912

(22) Filed: Oct. 24, 2008

(30) Foreign Application Priority Data
Feb. 12, 2008 (JP) 2008-031130
Jul. 10, 2008 (JP) 2008-179759

(51) Int. Cl. G06F 21/00

(52) U.S. Cl. 726/21

(57) ABSTRACT

An information processing system includes: storage that stores electronic information in which an operation authority for each of a plurality of users is set in each of a plurality of defined work states; an acceptance unit that accepts an operation request for electronic information stored in the storage, and an operation execution unit that executes an operation for the electronic information of operation object in accordance with the operation authority based on a non-administrator authority of the user in the work state of the electronic information if the operation request based on an administrator authority by the user having the administrator authority and the non-administrator authority for the electronic information is accepted by the acceptance unit.

### CROSS-REFERENCE TO RELATED APPLICATIONS

This application is based on and claims priority under 35 U.S.C. 119 from Japanese Patent Application No. 2008-031130 filed Feb. 12, 2008, and Japanese Patent Application No. 2008-179759 filed Jul. 10, 2008.

### BACKGROUND

1. Technical Field

The present invention relates to an information processing system, an information processing method, and a computer readable medium.

2. Related Art

An information processing system has been well known in which each state from the new creation to disposal of electronic information is defined to operate the business. A cycle from the new creation to disposal of electronic information is called a lifecycle of electronic information.

### SUMMARY

According to an aspect of the present invention, an information processing system includes: storage that stores electronic information in which an operation authority for each of a plurality of users is set in each of a plurality of defined work states; an acceptance unit that accepts an operation request for electronic information stored in the storage; and an operation execution unit that executes an operation for the electronic information of operation object in accordance with the operation authority based on a non-administrator authority of the user in the work state of the electronic information if the operation request based on an administrator authority by the user having the administrator authority and the non-administrator authority for the electronic information is accepted by the acceptance unit.

### BRIEF DESCRIPTION OF THE DRAWINGS

Exemplary embodiment of the present invention will be described in detail based on the following figures, wherein:

FIG. 1 is a functional block diagram showing an example of the essential configuration of an information processing system;

FIG. 2 is a functional block diagram showing an example of the hardware configuration of the information processing system;

FIG. 3 is a flowchart showing one example of the operation of the information processing system;

FIG. 4 is a flowchart showing one example of the operation of the information processing system;

FIG. 5 is a view showing an example of a user management table;

FIG. 6 is a view showing an example of an electronic information management table;

FIG. 7 is a view showing an example of a lifecycle management table;

FIG. 8 is a view showing an example of an affiliation management table;

FIG. 9 is a view showing an example of an execution right management table;

FIG. 10 is a functional block diagram showing another example of the essential configuration of the information processing system;

FIG. 11 is a flowchart showing another example of the operation of the information processing system;

FIG. 12 is a view showing an example of a system state management table;

FIG. 13 is a view showing another example of the system state management table;

FIG. 14 is a view showing another example of the electronic information management table; and

FIG. 15 is a flowchart showing another example of the operation of the information processing system.

### DETAILED DESCRIPTION

One embodiment of the present invention will be specifically described below with reference to the drawings.

### First Embodiment

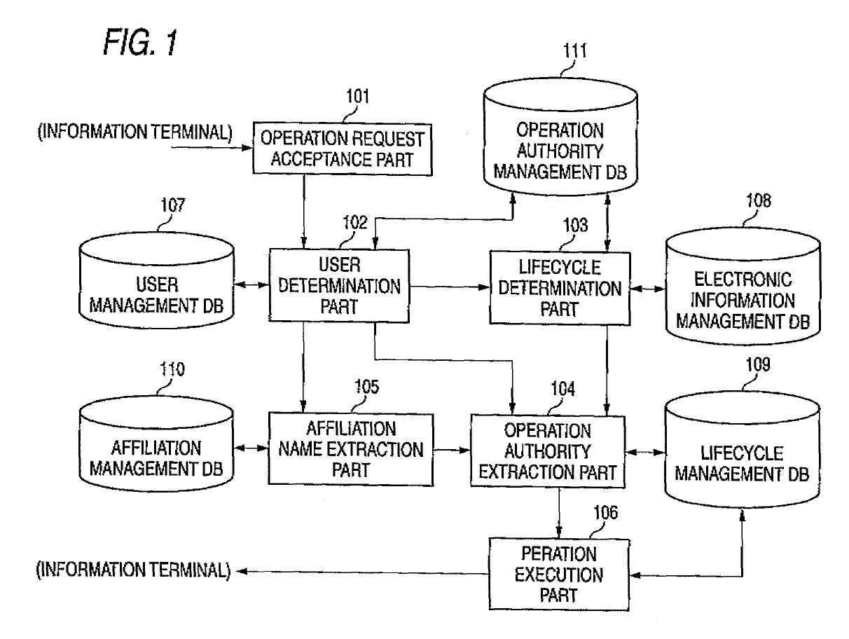

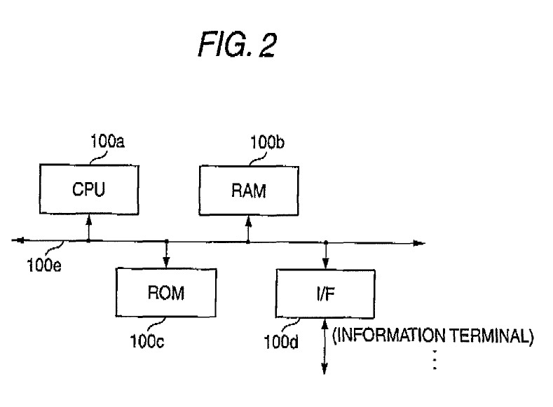

FIG. 1 is a functional block diagram showing an information processing system according to one embodiment of the invention, FIG. 2 is a functional block diagram showing an example of the hardware configuration of the information processing system. The information processing system according to this embodiment is one apparatus accommodated within one housing, but may be constituted of a plurality of apparatuses.

The information processing system comprises an operation request acceptance part 101, a user determination part 102, a lifecycle determination part 103, an operation authority extraction part 104, an affiliation name extraction part 105, an instruction execution part 106, a user management DB 107, an electronic information management DB 108, a lifecycle management DB 109, an affiliation management DB 110, and an execution right management DB 111, as shown in FIG. 1.

These functional blocks are connected with each other, the connection form is not specifically limited as far as the telecommunication or optical communication is enabled via the private line or public line, or by wireless. It should be noted that operation execution means of this embodiment is constituted of the operation request acceptance part 101, the user determination part 102, the lifecycle determination part 103, the operation authority extraction part 104, the affiliation name extraction part 105, the instruction execution part 106 and so on.

The operation request acceptance part 101 receives an operation request for electronic information from an information terminal operated by the user. The operation request includes electronic information discrimination information for discriminating the electronic information and user identification information for identifying the user. The operation request is a reading operation of opening electronic information, a write operation of writing in electronic information, an erase operation of erasing electronic information, or a print operation of printing electronic information, for example. The operation request acceptance part 101 receives an operation request, and sends it to the user determination part 102. It should be noted that the users are largely classified into the user (administrator) having operation authority with an administrator authority granted and the user (non-administrator) having operation authority without administrator authority granted.

The user determination part 102 receives the operation request, and searches the user management DS 107 based on user identification information given to the operation request. And the user determination part 102 determines whether or not the user identification information is user identification information having the administrator authority, and extracts affiliation identification information to which the user belongs. If the user determination part 102 determines that the user identification information is user identification information having the administrator authority, the user determination part 102 sends the operation request to the lifecycle determination part 103, and sends the affiliation identification information to the affiliation name extraction part 105.

The lifecycle determination part 103 receives the operation request, and searches the electronic information management DB 108 based on the electronic information discrimination information given to the operation request. And the lifecycle determination part 103 determines whether or not the electronic information discrimination information is managed in each work state of a plurality of defined work states. If the lifecycle determination part 103 determines that the electronic information discrimination information is managed in this way, the lifecycle determination part 103 extracts the lifecycle discrimination information and a lifecycle state flag according to the electronic information discrimination information, and sends them together with the operation request to the operation authority extraction part 104.

The operation authority extraction part 104 receives the operation request and the lifecycle discrimination information, and extracts the administrator operation authority that is operation authority for administrator according to the lifecycle discrimination information and the lifecycle state flag from the lifecycle management DB 109. Also, the operation authority extraction part 104 receives an affiliation name, extracts a lifecycle transition sequence reachable from the affiliation name from the lifecycle management DB 109, and extracts the non-administrator operation authority that is operation authority fox user according to this sequence. The operation authority extraction part 104 sends the non-administrator operation authority with the operation request to the operation execution part 105, after extraction.

The affiliation name extraction part 105 receives the affiliation identification information, extracts the affiliation name according to the affiliation identification information from the affiliation management DB 110 and sends it to the operation authority extraction part 104.

The operation execution part 106 receives the non-administrator operation authority and the operation request, acquires the administrator operation authority corresponding to the non-administrator operation authority from the lifecycle management DB 109, and judges whether or not the operation request is pertinent to the administrator operation authority. If the operation execution part 106 judges that the operation request is pertinent to the administrator operation authority, the operation execution part 106 executes the operation request.

Each function in the information processing system as described above is realized on a so-called computer, that is, the hardware configuration in which a processing apparatus 100a such as a CPU, a RAM 100b such as SRAM (Static Random Access Memory), DRAM (Dynamic RAM), SDRAM (Synchronous DRAM), or NVRAM (Nonvolatile RAM), a ROM (Read Only Memory) 100c such as a flash memory, an I/F 100d for controlling the input/output, and a hard disk, not shown, are connected via a bus 100e, as shown in FIG. 2.

Accordingly, the CPU 100a reads a required program stored in the ROM 100c or hard disk, and performs the operation according to the program to implement each functional block. It should be noted that such program may be realized according to a flowchart as will be described later.

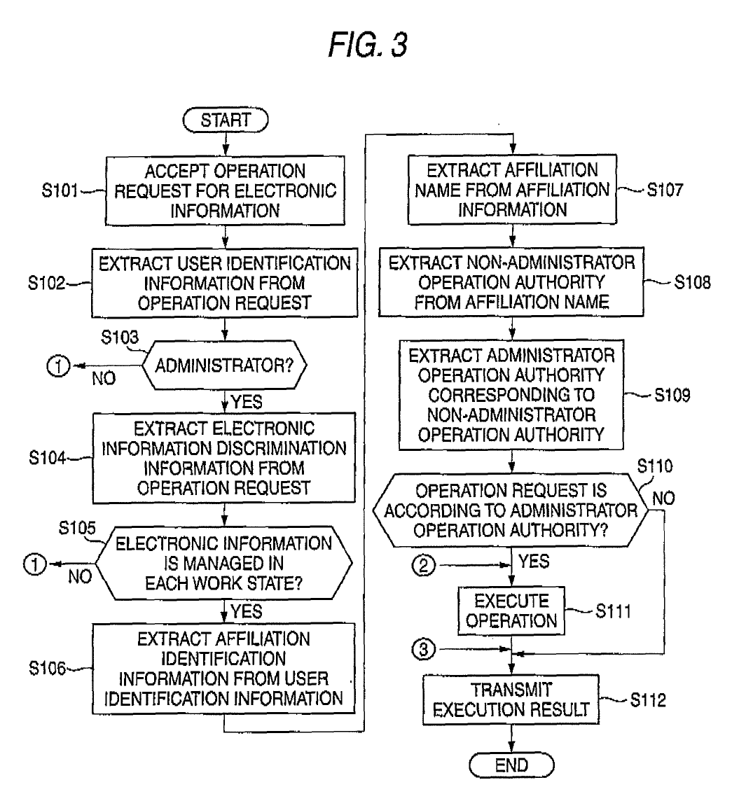

Referring to FIGS. 3 to 9, the operation of the information processing system according to one embodiment of the invention will be described below.

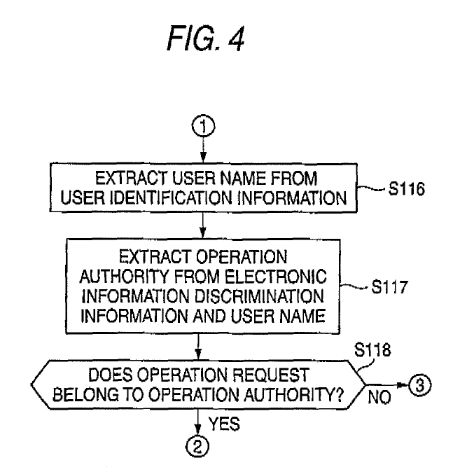

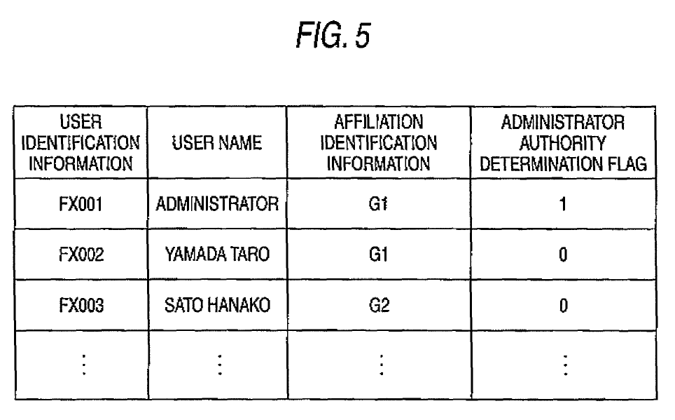

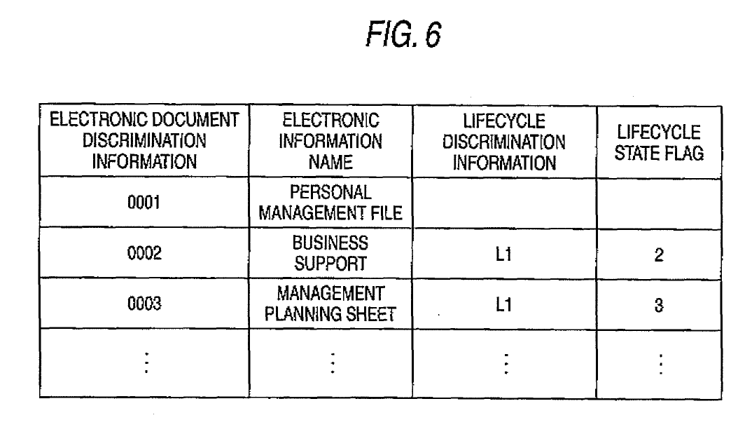

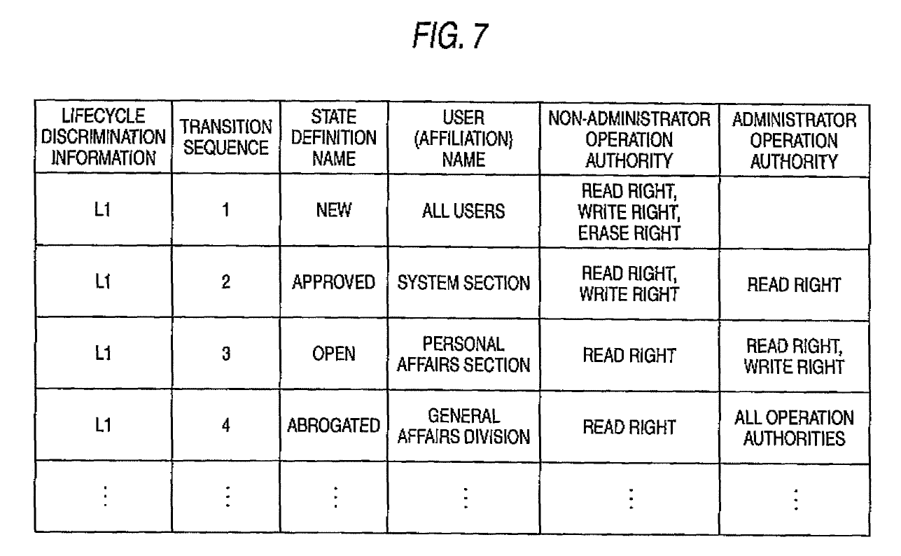

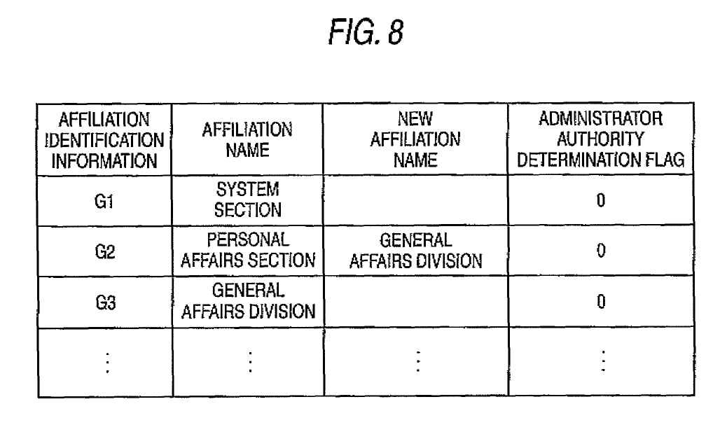

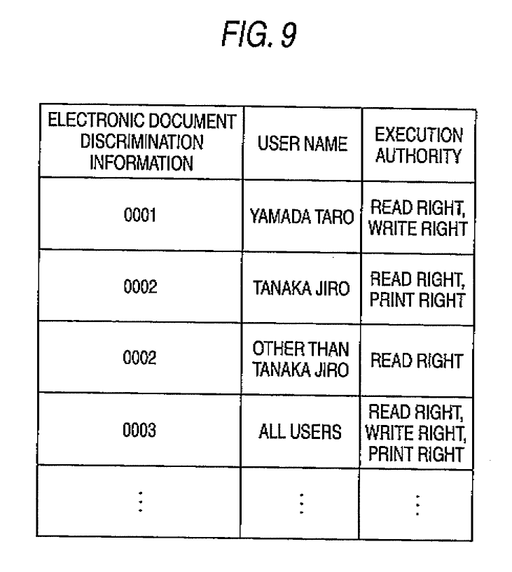

FIGS. 3 and 4 are the flowcharts showing one example of the operation of the information processing system. FIG. 5 is a view showing an example of a user management table. FIG. 6 is a view showing an example of an electronic information management table. FIG. 7 is a view showing an example of a lifecycle management table. FIG. 8 is a view showing an example of an affiliation management table. FIG. 9 is a view showing an example of an operation authority management table.

The user management table as shown in FIG. 5 is one example of a storage form of user identification information in the user management DB 107. Similarly, the electronic information management table as shown in FIG. 6 is one example of a storage form of electronic information discrimination information in the electronic information management DB 108, the lifecycle management table as shown in FIG. 7 is one example of a storage form of lifecycle discrimination information in the lifecycle management DB 109, the affiliation management table as shown in FIG. 8 is one example of a storage form of affiliation identification information in the affiliation management DB 110, and the execution right management table as shown in FIG. 9 is one example of a storage form of electronic information discrimination information in the operation authority management DB 111.

The operation request acceptance part 101 in the information processing system first of all accepts an operation request for electronic information (step S101), and extracts the user identification information appended to the operation request (step S102), and the user determination part 102 determines whether or not the user identification information is user identification information having the administrator authority (step S103), as shown in FIG. 3.

This determination process is performed by determining whether the administrator authority determination flag according to the user identification information “FX001” as shown in FIG. 5 is “1” or “0”, if the user identification information appended to the electronic information is “FX001”, for example. If the administrator authority determination flag is “1”, it is determined that the user identification information is user identification information having the administrator authority, whereas if the administrator authority determination flag is “0”, it is determined that the user identification information is user identification information having no administrator authority.

Herein, if the user determination part 102 in the information processing system determines that the user identification information is user identification information having the administrator authority, the lifecycle management part 103 extracts the electronic information discrimination information from the operation request (step S104). The lifecycle management part 103 determines whether or not the electronic information is managed in each work state of the plurality of defined work states (step S105).

This determination process is performed by determining whether the lifecycle discrimination information and the lifecycle state flag according to the electronic information discrimination information “0003” as shown in FIG. 6 exist if the identification information appended to the electronic information is “0003”, for example. If data such as “L1” exists in the lifecycle discrimination information, it is determined that the electronic information discrimination information is managed in each work state of the plurality of defined work states, whereas if does not exist, it is determined that the electronic information discrimination information is not managed in this way.

The user determination part 102 in the information processing system then extracts the affiliation identification information from the user identification information appended to the operation request (step S106). This extraction process is performed by extracting the affiliation identification information “G1” according to the user identification information “FX001” as shown in FIG. 5, if the user identification information is “FX001”, for example.

The affiliation name extraction part 105 in the information processing system then extracts the affiliation name from the affiliation identification information (step S107). This extraction process is performed by extracting the affiliation name “system section” according to the affiliation identification information “G1” as shown in FIG. 8, if the affiliation identification information is “G1”, for example.

The operation authority extracting part 104 in the information processing system then extracts the non-administrator operation authority from the affiliation name (step S109). This extraction process is performed by extracting a lifecycle transition sequence reachable from the affiliation name “system section” as shown in FIG. 7 and extracting the non-administrator operation authority “read right, write right” according to this sequence, if the affiliation name is “system section”, for example.

The operation authority extraction part 104 in the information processing system acquires the administrator operation authority “read right” in this transition sequence from the non-administrator operation authority extracted at the processing of step S108 (step S109).

As described above, the administrator operation authority extracted at the processing of step S109 is “read right”, and the administrator operation authority “read right” is operation authority given to the user identification information having the administrator operation authority.

The operation execution part 106 in the information processing system then determines whether or not the operation request is pertinent to the administrator operation authority (step S110). If the operation request is pertinent to the administrator operation authority, the operation request is executed (step S111). On the other hand, if the operation request is not pertinent to the administrator operation authority, the subsequent process is performed without skipping the processing at step S111.

In this way, in the case that the duplicate administrator operation authority is “read right”, the operation request “read operation” is executed if the operation request received at the processing of step S101 is “read operation” for electronic information. On the other hand, if the operation request received at the processing of step S101 is “write operation” for electronic information, the operation request “write request” is not executed. In this way, even with the operation request based on the user identification information having the administrator authority, the operation request is limited.

The operation execution part 108 in the information processing system sends the processing result to the information terminal that transmits the operation request (step S112), if the operation request is not pertinent to the administrator operation authority at the processing of step S110, or the processing at step S111 is ended, and the process is ended.

Also, if the user determination part 102 in the information processing system determines that the user is not administrator at the processing of step S103, or the lifecycle management part 103 determines that the electronic information is not managed in each work state of the plurality of defined work states at the processing of step S105, the user name is extracted from the user identification information extracted at the processing of step S102 (step S116), as shown in FIG. 4. This extraction process is performed by extracting the user name “Yamada Taro” according to the user identification information “FX002” as illustrated in FIG. 5, if the user identification information is “FX002”, for example.

The operation authority extraction part 104 in the information processing system then extracts the operation authority from the electronic information discrimination information extracted at the processing of step S104 and the user name extracted at the processing of step S116 (step S117). This extraction process is performed by extracting the operation authority “read right, write right” according to the electronic information discrimination information “0001” and the user name “Yamada Taro” as shown in FIG. 9, for example.

The operation authority extracting part 104 in the information processing system determines whether or not the operation request received at the processing of step S101 is operation request pertinent to the extracted operation authority (step S118). For example, if the received operation request is “write operation”, it is determined that the operation request “write operation” is pertinent to the operation authority, because the operation authority extracted at the processing of step S117 is “read right, write right”. On the other hand, if the received operation request is “print operation”, it is determined that the operation request is not pertinent to the operation authority.

The operation execution part 106 in the information processing system performs the processing of step S111 to execute the operation request, if it is determined that the received operation request is pertinent to the extracted operation authority. On the other hand, the operation execution part 106 does not perform the processing of step S111, if it is determined that the received operation request is not pertinent to the extracted operation authority.

In this way, the operation of the information processing system is changed depending on the operation request transmitted from the information terminal and received, as well as the user identification information and electronic information discrimination information appended to this operation request. For example, in the case of receiving the operation request for electronic information managed in each work state of the plurality of defined work states, the operation request based on the user identification information with the administrator identification information appended is limited if the information processing system determines that the operation request is based on the user identification information with the administrator identification information appended, whereby unconformity on the electronic information is restrained.

### Second Embodiment

A second embodiment of the present invention will be described below.

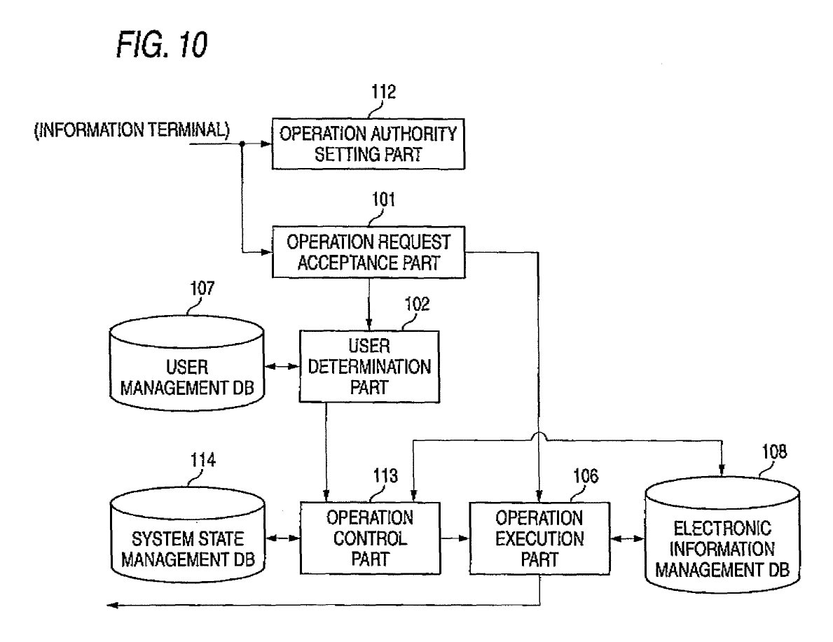

FIG. 10 is a functional block diagram showing the essential configuration of an information processing system according to the second embodiment of the invention. It should be noted that the same or like parts are designated by the same reference numerals as in the information processing system as shown in FIG. 1 and not described here.

The information processing system according to this embodiment further comprises an operation authority setting part 112, an operation control part 113, and a system state management DB 114, differently from the first embodiment.

The operation authority setting part 112 sets the operation authority including the administrator authority or the operation authority not including the administrator authority for each user. The user for whom the operation authority including the administrator authority is set can perform a predetermined operation such as installing or uninstalling the software, or applying modified patch for the installed software, for example, in a certain state.

The operation control part 113, when in a certain state, outputs a gist that the operation for the operation request is permitted to the operation execution part 106. Conversely, the operation control part, when not in the certain state, outputs a gist that the operation for the operation request is inhibited is outputted to the operation execution part 106. Herein, the certain state may be an active state, a maintenance state or an abnormal state of the system, for example. Whether or not the system is in the certain state is checked by referring to the system state management DB 114 for managing the state of the system.

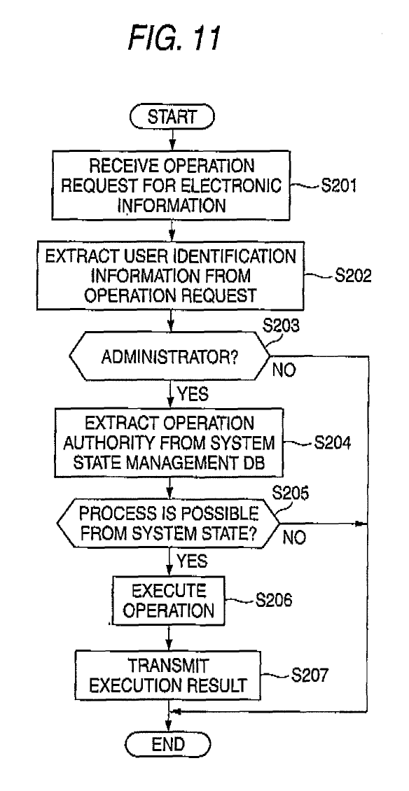

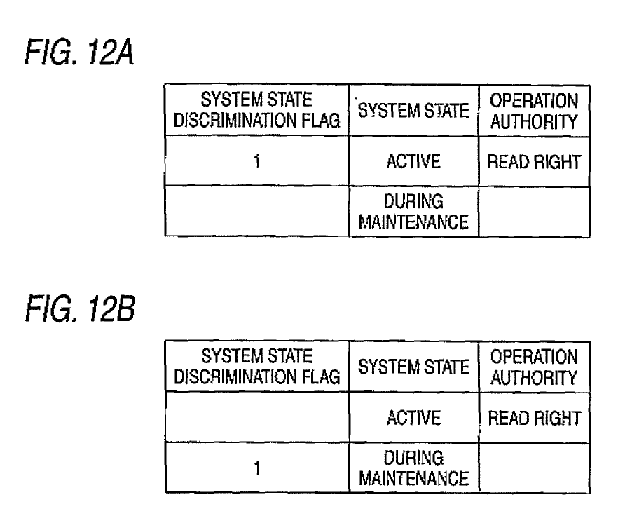

Referring to FIGS. 11 and 12, the operation of the information processing system according to the second embodiment of the invention will be described below.

FIG. 11 is a flowchart showing one example of the operation of the information processing system, and FIG. 12 is a view showing an example of a system state management table.

The operation request acceptance part 101 in the information processing system accepts an operation request for electronic information stored in the electronic information management DB 108 from the information terminal (step S201). The user determination part 102 extracts the user identification information included in the operation request (step S202), and determines whether or not the operation authority including the administrator authority is set for the user by referring to the user management DB 107 (step S203).

If the user determination part 102 determines that the operation authority including the administrator authority is set for the user at the processing of step S203, the operation control part 104 acquires the operation authority corresponding to the system state from the system state management DB 114 (step S204), More specifically, the operation request outputted from the information terminal is the operation request for “print operation” of the electronic information “0002”, and the user identification information included in the operation request is “FX001”, the user determination part 102 refers to the user management DB 107 based on the user identification information “FX001”. Since the user name according to the identification information is “administrator” and the administrator authority determination flag is “1”, as shown in FIG. 5, it is determined that the operation authority including the administrator authority is set for the user.

Moreover, the operation control part 113 acquires the operation authority “read right” corresponding to the system state “active” with the system state discrimination flag “1” appended, as shown in FIG. 12A.

The operation control part 113 determines whether or not the process for the operation request is possible from the system state (step S205). As described above, in the case where the operation authority “read right” is acquired, the operation of the administrator for the electronic information is limited to the “read process”, if the operation request is for the electronic information “0002”, for example. On the other hand, if the operation request accepted by the operation request acceptance part 101 is the operation request for “print”, the operation control part 113 controls the operation execution part 106 to disable the operation for the operation request. It should be noted that if the process for the operation request is on the fly, the process may be forcefully stopped.

On the other hand, if the operation request accepted by the operation request acceptance part 101 is the operation request for “read”, for example, the “read operation” for the operation request is performed to handle the “read right” corresponding to the system state “active” (step S207). It should be noted that if the system state discrimination flag is “1” and the system state is the “during maintenance”, as shown in FIG. 12B, the operation is executed, irrespective of whether the process for the operation request is the “print” process or “read” process, because the operation authority is not limited.

In this way, the process for the operation request of the administrator may or may not be performed depending on the system state and the operation authority assigned to the system state. That is, even for the administrator, the process for the operation request is limited.

Though in the second embodiment the registration object of the operation authority registered in the system management DB 114 is the right “permitted” for the administrator as shown in FIG. 12, it should be noted that the operation authority inhibited for the administrator may be conversely the registration object, or all the operations for use in the system may be inhibited for the administrator. Thereby, even the administrator is prevented from inadvertently changing the settings.

Though in the second embodiment, if the system state is the “during maintenance”, there is no limitation by the operation authority, it should be noted that even if the system state is “active”, for example, there may be no limitation by the operation authority depending on the uptime. Thereby, if an abnormality occurs while the system is active, or data unconformity occurs, the process for various operation requests can be made.

### Third Embodiment

A third embodiment of the present invention will be described below.

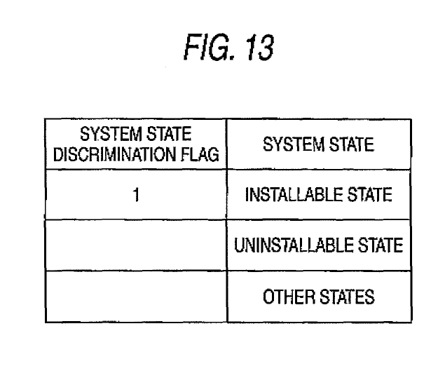

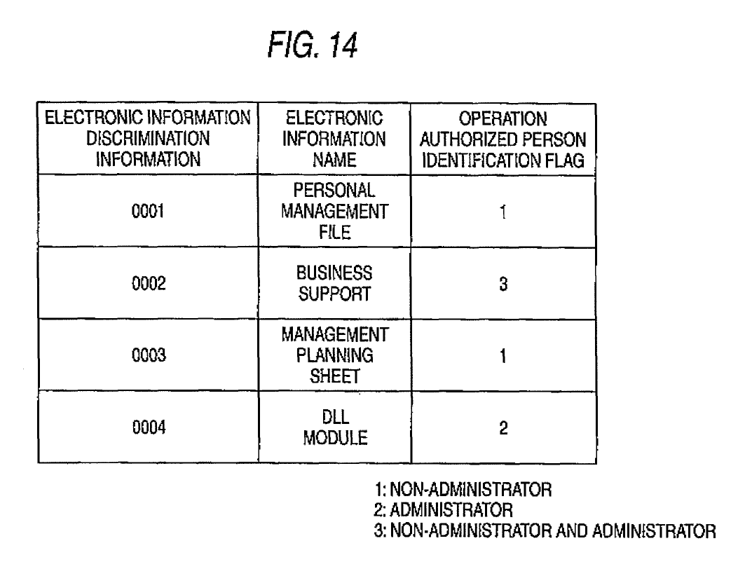

FIG. 13 is a view showing an example of the system state management table, and FIG. 14 is a view showing an example of the electronic information management table.

The third embodiment is different from the previous embodiments in that whether or not the operation requested by the administrator can be made is distinguished depending on a combination of the person who is permitted for the operation for electronic information and the system state.

More specifically, in the system state management DB 114, the system state is managed by the system state management table composed of the system state discrimination flag and the system state, as shown in FIG. 13. The system state with the system state discrimination flag “1” appended indicates the current state, in which the current state is an “installable state”, as shown in FIG. 13.

In the electronic information management DB 108, the operation authorized person for electronic information is managed according to the electronic information management table composed of the electronic information discrimination information, electronic information name and operation authorized person identification flag, as shown in FIG. 14. The electronic information discrimination information “0004” indicates that only the administrator is permitted for the operation, as shown in FIG. 14.

Referring to FIGS. 13 to 15, the operation of the information processing system according to this embodiment will be described below.

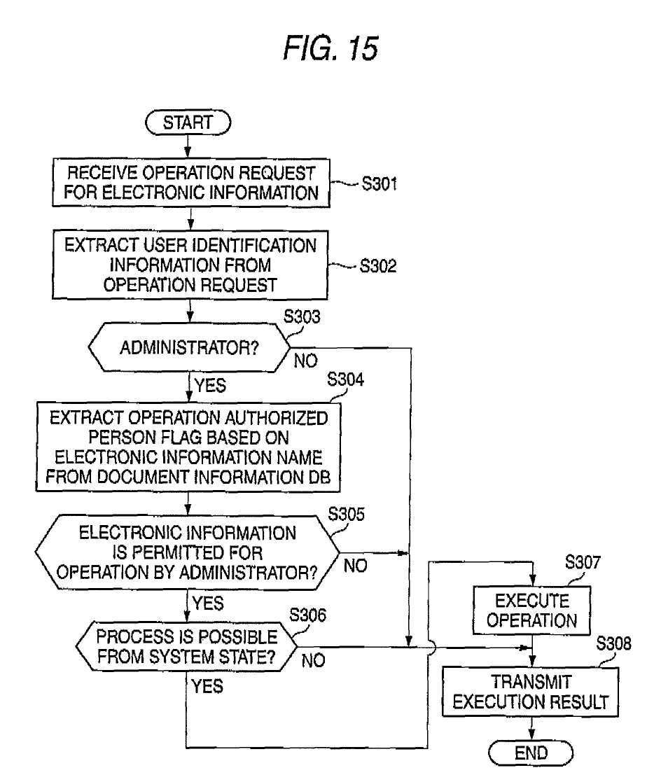

FIG. 15 is a flowchart showing another example of the operation of the information processing system.

The operation request acceptance part 101 in the information processing system accepts an operation request for electronic information stored in the electronic information management DB 108 from the information terminal (step S301). The user determination part 102 extracts the user identification information included in the operation request (step S302), and determines whether or not the operation authority including the administrator authority is set for the user by referring to the user management DB 107 (step S303).

If the user determination part 102 determines that the operation authority including the administrator authority is set for the user at the processing of step S303, the operation control part 104 acquires the operation authorized person identification flag from the electronic information management DB 108 (step S304). More specifically, if the operation request received by the operation request acceptance part 101 is the operation request for the electronic information “0004”, as shown in FIG. 14, the operation authorized person corresponding to the electronic information acquires the “2 (administrator)”.

The operation control part 113 determines whether or not the electronic information can be operated by the administrator (step S305). Since the acquired operation authorized person identification flag is “2 (administrator)” as described above, it is determined that the electronic information can be operated.

Further, the operation control part 113 determines whether or not the process for the operation request is possible from the system state (step S306). More specifically, if the system state is an installable state or an uninstallable state as shown in FIG. 13, it is judged that the process for the operation request is possible. These states may be appropriately set.

If it is judged that the operation for the operation request is possible from the system state at the processing of step S306, the operation control part 113 controls the operation execution part 106 to perform the operation for the operation request (step S307). On the other hand, if it is judged that the process for the operation request is impossible from the system state, the operation control part 113 controls the operation execution part 106 not to perform the process for the operation request.

Thereby, the electronic information important on the system operation such as the electronic information indispensable for the control is limited on the operation, when the system is not in the certain state, even though the operation is performed by the administrator. And only in the case of the installable state, the administrator can operate the electronic information Therefore, the important file on the system operation is protected against the inadvertent operation.

Though the “permission” of the operation is controlled depending on the state registered in the system state management DB 114 in the third embodiment, the “inhibition” of the operation may be conversely controlled depending on the registered state. Also, when the system is in the abnormal state, the limitation may not be placed. There is possibility to make an operation on the important file in the effective management in some instances.

While the preferred embodiments of the invention have been described above, it will be understood that the invention is not limited to the specific embodiments, but various variations or modifications may be made thereto without departing from the spirit or scope of the invention as defined in the claims. For example, a program of the invention may be distributed via communication means or stored in the storage medium such as a CD-ROM and provided.

The above information terminals may or may not be the same information terminal. In the case where the same information terminal is shared between the non-administrator and the administrator, the settings must be made such that the administrator and the non-administrator are distinguished in using the information terminal. Also, the information terminal may be a PC (Personal Computer), a portable telephone, or a PDA (Personal Digital Assistants).

Moreover, if a system failure is detected in the information processing system, the above-described limitation may be disabled. The system failure may be an execution processing error due to a program bug, for example. Thereby, when there is an emergency, the operation can be performed by avoiding the limited execution.

Also, if the administrator authority determination flag for the user identification information is not stored in the user management DB 107, the administrator determination is impossible, whereby the above-described limitation is disabled. In this way, the operation may be performed without distinction between the administrator and the non-administrator.

Also, if the time or period for which the lifecycle state flag of electronic information managed in each work state of the plurality of defined work states remains in one state is measured and passes a predetermined time, the above-described limitation may be disabled. That is, if there is no operation request for the electronic information managed in each work state of the plurality of defined work states within a predetermined period, and there is no change in the state, the above-described limitation is not placed.

In the above embodiments, the electronic information may include electronically generated documents, drawings, tables, folder, binder, cabinet, and so on. Also, the administrator may include the user having the special authority that can not be used by the non-administrators, in addition to the authority of managing the system state, and maintenance of creating or deleting the management data such as cabinet.

In the above embodiments, the administrator may directly make an instruction to this system, or indirectly make an instruction via application software for the administrator.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing system comprising:
storage that stores electronic information in which an operation authority for each of a plurality of users is set in each of a plurality of defined work states;
an acceptance unit that accepts an operation request for electronic information stored in the storage; and
an operation execution unit that executes an operation for the electronic information of operation object in accordance with the operation authority based on a non-administrator authority of the user in the work state of the electronic information if the operation request based on an administrator authority by the user having the administrator authority and the non-administrator authority for the electronic information is accepted by the acceptance unit.

2. The information processing system as claimed in claim 1, wherein
the operation execution unit executes an operation for the electronic information of operation object in accordance with the operation authority based on the administrator authority of the user who makes the operation request, if a failure contained in the information processing system is detected.

3. The information processing system as claimed in claim 1, wherein
the operation execution unit executes an operation for the electronic information of operation object in accordance with the operation authority based on the administrator authority of the user who makes the operation request, if the time for which the electronic information of operation object remains in one work state of the plurality of work states exceeds a predetermined time.

4. An information processing system comprising:
a setting unit that sets a first operation authority or a second operation authority different from the first operation authority for each user;
an acceptance unit that accepts an operation request for electronic information stored in storage;
an operation execution unit that executes an operation for the electronic information; and
an operation control unit that enables an execution of an operation with the operation execution unit in accordance with the operation request when in a predetermined state, and disables an execution of the operation with the operation execution unit in accordance with the operation request when not in the predetermined state, if the acceptance unit accepts the operation request for the electronic information that can not be operated with the second operation authority from the user for whom the first operation authority is set.

5. An information processing system comprising:
a setting unit that sets a first operation authority ox a second operation authority different from the first operation authority for each user;
an acceptance unit that accepts an operation request for electronic information stored in storage;
an operation execution unit that executes an operation for the electronic information; and
an operation control unit that enables an execution of an operation with the operation execution unit in accordance with the operation request when in a predetermined state, and disables an execution of the operation with the operation execution unit in accordance with the operation request when not in the predetermined state, if the acceptance unit accepts the operation request for the electronic information that can not be operated with the second operation authority in a condition in service by the user for whom the first operation authority is set.

6. An information processing method comprising;
storing electronic information in which an operation authority for each of a plurality of users is set in each of a plurality of defined work states;
accepting an operation request for the stored electronic information; and
executing an operation for the electronic information of operation object in accordance with the operation authority based on a non-administrator authority of the user in the work state of the electronic information if the operation request based on an administrator authority by the user having the administrator authority and the non-administrator authority for the electronic information is accepted in the accepting of the operation request.

7. An information processing method comprising:
setting a first operation authority or a second operation authority different from the first operation authority for each user;
accepting an operation request for the stored electronic information;
executing an operation for the electronic information; and
enabling an execution of an operation in accordance with the operation request when in a predetermined state, and disabling an execution of the operation in accordance with the operation request when not in the predetermined state, if the accepting of the operation request accepts the operation request for the electronic information that can not be operated with the second operation authority in a condition in service by the user for whom the first operation authority is set.

8. A computer readable medium storing a program causing a computer, which is connected to storage for storing electronic information in which an operation authority for each of a plurality of users is set in each of a plurality of defined work states, to execute a process for performing an information processing, the process comprising:
accepting an operation request for the electronic information; and
executing an operation for the electronic information of operation object in accordance with an operation authority based on a non-administrator authority of a user in a work state of the electronic information, if the operation request for the electronic information based on an administrator authority by the user having the administrator authority and the non-administrator authority is accepted in the accepting of the operation request.

9. The computer readable medium as claimed in claim 8, wherein
the executing of the operation comprises executing the operation for the electronic information of operation object in accordance with the operation authority based on the administrator authority of the user who makes the operation request, it a failure contained in a system including the storage is detected.

10. The computer readable medium as claimed in claim 8, wherein
the executing of the operation comprises executing the operation for the electronic information of operation object in accordance with the operation authority based on the administrator authority of the user who makes the operation request, if the time for which the electronic information of operation object remains in one work state of the plurality of work states exceeds a predetermined time.

11. A computer readable medium storing a program causing a computer to execute a process for performing an information processing, the process comprising:
setting a first operation authority or a second operation authority different from the first operation authority for each user;
accepting an operation request for electronic information;
executing an operation for the electronic information; and
enabling the execution of an operation with the executing of the operation in accordance with the operation request when the computer is in a predetermined state, or disabling the execution of the operation with the executing of the operation in accordance with the operation request when the computer is not in the predetermined state, if the operation request for the electronic information that can not be operated with the second operation authority from the user for whom the first operation authority is set is accepted with the accepting of the operation request.

12. A computer readable medium storing a program causing a computer to execute a process for performing an information processing, the process comprising:
setting a first operation authority or a second operation authority different from the first operation authority for each user;
accepting an operation request for electronic information;
executing an operation for the electronic information; and
enabling the execution of an operation with the executing of the operation in accordance with the operation request when the computer is in a predetermined state, or disabling the execution of the operation with the executing of the operation in accordance with the operation request when the computer is not in the predetermined state, if the accepting of the operation request accepts the operation request for the electronic information that can not be operated with the second operation authority in a condition in service by the user for whom the first operation authority is set.

13. The computer readable medium as claimed in claim 12, wherein
the predetermined state is a state of executing a process for installing a software.

14. The computer readable medium as claimed in claim 12, wherein
the predetermined state is a state of executing a process for uninstalling an installed software.

15. The computer readable medium as claimed in claim 12, wherein
the predetermined state is a state of detecting a failure.
